(19) United States
(12) Patent Application Publication
(10) Pub. No.: US 2016/0123752 A1
(43) Pub. Date: May 5, 2016

(54) ESTIMATING AND PREDICTING FUEL USAGE WITH SMARTPHONE

(71) Applicant: Microsoft Corporation, Redmond, WA (US)

(72) Inventors: Srikanth Kandula, Redmond, WA (US); Mohammed Shoaib, Redmond, WA (US); Paramvir Bahl, Bellevue, WA (US); Ashish Patro, Madison, WI (US)

(21) Appl. No.: 14/529,100

(22) Filed: Oct. 30, 2014

(51) Int. Cl. G01C 21/34

(52) U.S. Cl. CPC G01C 21/3469

(57) ABSTRACT

Examples are disclosed herein that relate to estimating and predicting vehicular fuel use. One example estimates fuel usage by a vehicle during a trip by obtaining sensor measurements from one or more sensors of a mobile computing device during the trip, determining a plurality of trip features from the sensor measurements, each trip feature representing an aspect of one or more of energy produced and energy consumed during the trip, obtaining vehicle-specific parameters of the vehicle, and determining an estimated fuel usage from the vehicle-specific parameters and the plurality of trip features for output by the computing device.

### BACKGROUND

Estimating fuel usage during a trip and/or predicting fuel usage prior to taking a trip may help a driver, fleet operator, etc. to pick routes, locate fuel stops, and budget for fuel purchases. Fuel usage for a trip is commonly estimated or predicted from average miles per gallon values for city and highway driving that are published for a vehicle.

### SUMMARY

Examples are disclosed herein that relate to estimating and predicting vehicular fuel use. One example estimates fuel usage by a vehicle during a trip by obtaining sensor measurements from one or more sensors of a mobile computing device during the trip, determining a plurality of trip features from the sensor measurements, each trip feature representing an aspect of one or more of energy produced and energy consumed during the trip, obtaining vehicle-specific parameters of the vehicle, and determining an estimated fuel usage from the vehicle-specific parameters and the plurality of trip features for output by the computing device.

Another example predicts fuel usage for a vehicle by obtaining map information for a trip having a route, obtaining road characteristic information for the route from the map information, the road characteristic information defining road features for the route, obtaining a plurality of trip features from the map information and road characteristic information, the plurality of trip features comprising effects of the road features on a vehicle traveling the route, obtaining vehicle-specific parameters for the vehicle, and determining a predicted fuel usage for the trip from the vehicle-specific parameters and the plurality of trip features for output by the computing device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example user interface for an application for predicting and/or estimating fuel usage.

FIG. 2 is a plot of an example distribution of fuel efficiencies across various vehicles.

FIG. 3 is a plot of an example of fuel use as a function of distance traveled for various vehicles.

FIG. 4 is a plot of a cumulative fraction of all rides of an example set of rides compared to fuel use of a ride divided by average fuel use of all rides between the same begin and end locations.

FIG. 5 is a graph of percentage of rides having fuel use outside given error thresholds of ±10%, ±20%, and ±50% from the average fuel use for the example set of rides of that in FIG. 4.

FIG. 6 shows an example user interface for a fuel usage estimation application.

FIG. 7 is a flow diagram illustrating an example method of estimating fuel usage.

FIG. 8 depicts a graph of fuel used, energy used to counteract rolling resistance, energy used to counteract aerodynamic drag, potential energy change, kinetic energy change, and stops for an example ride over time.

FIG. 9a is a plot of average observed speed achieved by drivers versus posted speed limit per road segment for an example set of trips.

FIG. 9b is a plot of the standard deviation of speed versus the average speed per road segment for the example set of trips of FIG. 9a.

FIG. 10a is a plot of an example of actual number of stops in a trip versus inferred number of stops from a map for the example set of trips of FIG. 9a.

FIG. 10b is a plot of an example of the percentage of trip durations spent in a stop versus the total trip distances for the example set of trips of FIG. 9a.

FIG. 11a shows an example user interface for a fuel usage prediction application prior to user input.

FIG. 11b shows an example user interface for a fuel usage prediction application after user input.

FIG. 12 shows a flow diagram depicting an example method of predicting fuel usage.

FIG. 13 shows a plot of the absolute value of estimation error versus the duration over which the estimate was computed for an example set of trips.

FIG. 14 shows a plot of cumulative fraction of all rides versus relative prediction error across predictive schemes for the example set of trips of FIG. 13.

FIG. 15 shows a plot of cumulative fraction of all rides versus relative prediction error across additional predictive schemes for the example set of trips of FIG. 13.

FIG. 16 depicts a graph of per-component contributions to various fuel consumption components of three example drivers.

FIG. 17 depicts a graph of per-component contributions to various fuel consumption components of eight example drivers.

FIG. 18 shows a block diagram of an example computing system.

### DETAILED DESCRIPTION

As mentioned above, predicting fuel usage may help drivers to estimate the cost of a trip, choose routes that may save fuel (e.g. avoiding hilly or congested routes), estimate locations for fuel stops, and/or improve driving behavior, among other possible benefits. Further, operators of fleets of vehicles, such as a shuttle system or a cab network, may schedule trips based upon predicted fuel use to conserve fuel, and thereby reduce costs of business and greenhouse gas emissions while meeting user requirements such as timeliness. Fuel usage prediction may also be useful for auto manufacturers, for example, to indicate conditions in which vehicles use more fuel. Fuel usage prediction may also help road designers with infrastructure plans, among other potential uses.

Current methods of predicting fuel use for a vehicle may be based on a published miles-per-gallon (MPG) taken from Environmental Protection Agency (EPA) testing of a vehicle make and model for city or highway conditions. However, predictions of fuel use based on such MPG figures may not be accurate in various scenarios. For example, EPA MPG estimates may be determined from test drives conducted on a closed circuit. Such test drives may not be representative of real world conditions, as the acceleration and braking patterns on a real road may differ from those in a controlled test circuit. Also, tire pressure and tire quality may vary, as well as use of air conditioning and other electrical equipment.

Fuel estimates made based on EPA MPG also do not take into account actual roads to be traversed in a trip, or the driving behaviors of the driver. For example, the speed a driver maintains on the roads may impact aerodynamic drag, which may affect how long the trip will take and thus how much fuel will be consumed. Also, the grade of the road may impact changes in the potential energy changes of a vehicle during the trip, which may also affect fuel consumption. Further, changes in vehicle speed during the trip may increase kinetic energy expended, which may increase fuel consumption. Changes in vehicle speed may arise from, for instance, traffic congestion, traffic signals, and/or the driver's braking behavior. As such, aspects which impact fuel use may be static (e.g. road grade), may change with time (e.g. congestion), and/or may be driver-specific (e.g. acceleration and/or braking behavior). Thus, numerous factors that may affect the fuel consumption of a vehicle on a trip are not taken into account by applying official MPG estimates for the vehicle to the distance of the trip.

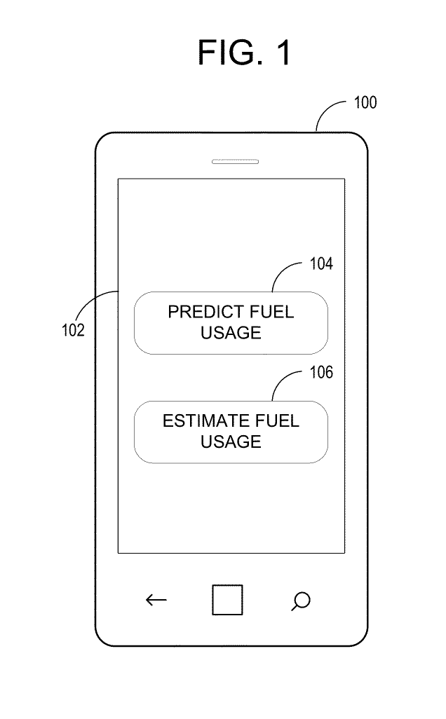

Accordingly, examples are disclosed herein that relate to predicting fuel use by a vehicle for a trip, and also to estimating fuel usage post-trip, via sensors located on a mobile computing device, such as a smart phone. FIG. 1 depicts an example smartphone 100 and shows an example user interface 102 for an application for estimating and predicting fuel use. Pre-trip fuel estimation, as discussed above, may help with planning, budgeting, and scheduling for fuel, by both individuals and organizations. Post-trip fuel use estimation may help to provide information regarding where and how fuel was spent along the trip, such as in relation to certain driving behaviors. Further, by comparing post-drive information with that of other drivers traversing similar roads, information may be obtained regarding the impact of driving styles on fuel usage. Additionally, post-trip fuel use estimation also may be used to model or otherwise inform pre-trip fuel use predictions.

As described below, post-trip fuel usage estimations may be determined based on sensor readings taken during a trip via a mobile computing device, such as a smartphone, tablet, wearable device, etc. For example, to help obtain data for use in both estimating and predicting fuel usage, a mobile computing device application may be used during trips in a vehicle to record Global Positioning System (GPS), accelerometer and/or gyroscope readings for the trip. Further, for obtaining ground-truth data to which such sensor measurements can be correlated, an on-board diagnostics (OBD) device that plugs into an OBD port in vehicles may be used. Where an OBD device is used, the mobile computing device application may connect with the OBD device, such as via Bluetooth or other suitable wired or wireless communication channel, and periodically query the vehicle's engine control unit for data. Additionally, road information, such as road grade and traffic signals, may be acquired by matching GPS readings to existing road maps that may be available from map vendors, databases, etc. Such information, collected for multiple drivers over time, may provide a data set that may be used for predicting and/or estimating fuel usage by other drivers and/or for other trips.

One possible challenge in using phone sensor readings to estimate vehicular fuel use may be in understanding the various aspects that require fuel to be spent, and determining how to measure these aspects from a phone sensor. To address this challenge, sensor readings may be input to a vehicular energy model of the energy used by a moving vehicle. Various vehicle-specific parameters may play a role in the energy model, including but not limited to the mass of the vehicle and the vehicle's frontal area for aerodynamic drag. Values of such vehicle-specific parameters may be inferred based on a regression between the sensor readings and the ground truth data obtained from an OBD device.

It will be understood that some aspects of energy use may not be measurable by mobile sensors alone. For example, the product of torque and velocity may indicate energy produced by a vehicle's engine, but only a portion of this information may be sensed from vehicular motion due to transmission losses in the drivetrain. Thus, to better understand such aspects, predictions that utilize phone sensor readings may be compared with predictions that use additional input available from an OBD device.

Further, in many instances, ground truth data may not be available, as vehicles may not include OBD devices, or drivers may not wish to install an OBD communications device. Thus, to overcome this issue in such instances, data for fuel usage estimation (and prediction) for a driver and a trip may be based on the sensor readings obtained from other drivers who traversed overlapping road segments. Such information also may be used to predict fuel usage on roads for which no fuel usage data from other drivers exists. For example, a road state model may relate observable parameters of a road (e.g. posted speed limit, traffic signals) to any energy usage terms in the vehicular energy model obtained from mobile device sensors and potentially OBD devices. Thus, a road state model may serve as a substitute for readings that may not be readily obtained from mobile device sensors.

Before discussing the disclosed examples of estimation and prediction of fuel usage in more detail, further information is presented to illustrate problems with using EPA MPG values to estimate and predict fuel usage. The data presented herein was gathered by deploying a smartphone data gathering application and OBD devices in the vehicles of twenty volunteers. Table 1 shows a breakdown of miles travelled by the volunteer drivers.

TABLE 1
Breakdown of miles traveled in example dataset for trips

| | | Miles traveled |
|---|---|---|
| Aspect | Quantity of aspect | (percentage of total miles) |
| Engine Size | 1.4 | 10% |
| (liters) | 1.8 | 15% |
| | 2.4 | 7% |
| | 2.5 | 28% |
| | 3 | 18% |
| | 3.5 | 10% |
| | 3.8 | 12% |
| | others | 2% |
| Vehicle Make | Acura | 5% |
| | Audi | 10% |
| | Chevy | 10% |
| | Ford | 20% |
| | Lexus | 13% |
| | Scion | 14% |
| | Subaru | 17% |
| | Toyota | 4% |
| | others | 7% |
| Road grade | <1° | 40% |
| | 1°-5° | 47% |
| | >5° | 13% |
| Speed range | <10 mph | 2% |
| | 10-40 mph | 48% |
| | 41-70 mph | 50% |
| | >70 mph | 1% |

The total number of miles driven in the experiment was approximately 4,423 miles for a total of 151 hours travelled on 15,846 unique road segments. Table 1 shows a wide range of vehicle manufacturers and engine sizes varying from small sedans (≦2 liter engines) to large SUVs (>3 liter engines). Approximately half of the miles driven were from roads with non-trivial banking grades (θ>1°). Also, approximately half of the miles driven were at speeds below 40 miles-per-hour (mph), and the remainder of the miles were driven at speeds above 40 mph, indicating a relatively even mix of highway and surface-road miles.

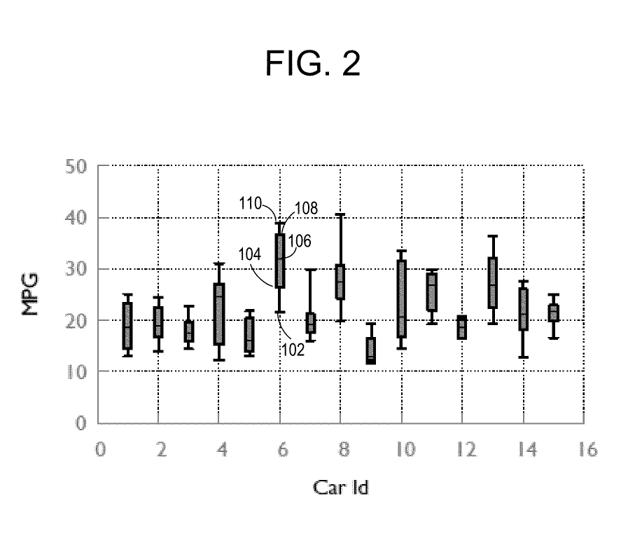

From the data gathered, it was found that fuel efficiency for vehicles varied over time. FIG. 2 shows the per-vehicle distribution of fuel efficiency in miles per gallon (MPG) of the vehicles used in the experiment. The 10^{th}, 25^{th}, 50^{th}, 75^{th,} and 90^{th} percentile values are shown for each vehicle, as indicated by 102, 104, 106, and 108, respectively. For a majority of the vehicles in FIG. 2, the inter-quartile difference, shown in gray between the 25^{th} and 75^{th} percentile values, is larger than 30% of the average MPG for the vehicle. For over 70% of the vehicles, the observed median fuel efficiency was up to 10 MPG outside of the range indicated by MPG estimates for city and highway use. It may be noted that the MPG estimates for a vehicle may have a relatively wide range to begin with, as the MPG estimate for city driving may be 6-10 MPG less than the highway estimate.

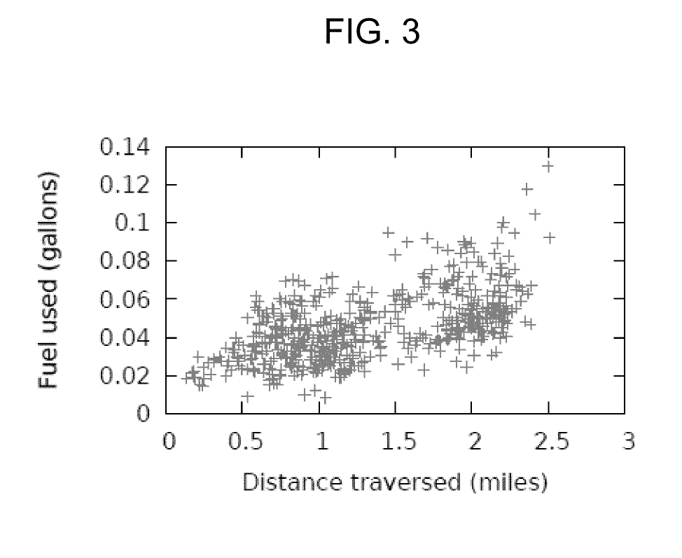

To further illustrate the potential variation in fuel use across vehicles, FIG. 3 plots the fuel used versus the distance travelled in contiguous two minute periods across all vehicles. The points appear to cluster into two groups in the plot of FIG. 3, where the points on the right are from faster roads. However, even within each group, there is substantial variation in fuel used for a distance travelled. Thus, fuel use predictions based on expected MPG may not be accurate for use in predicting or estimating fuel usage during a trip.

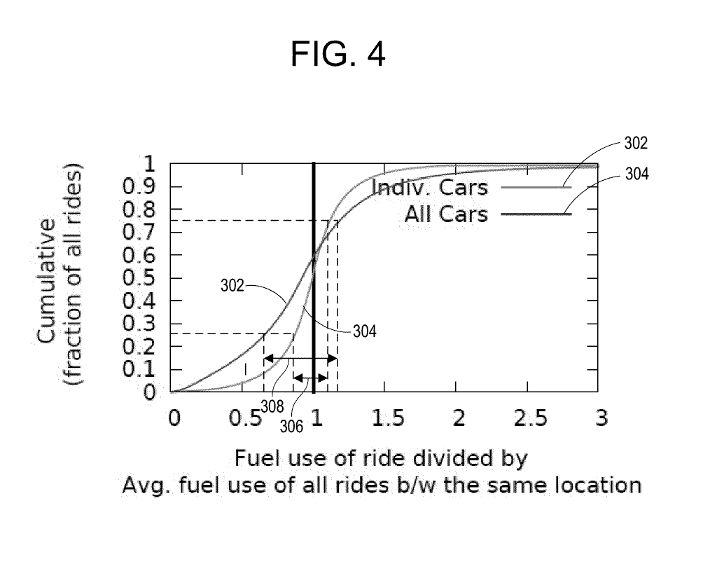

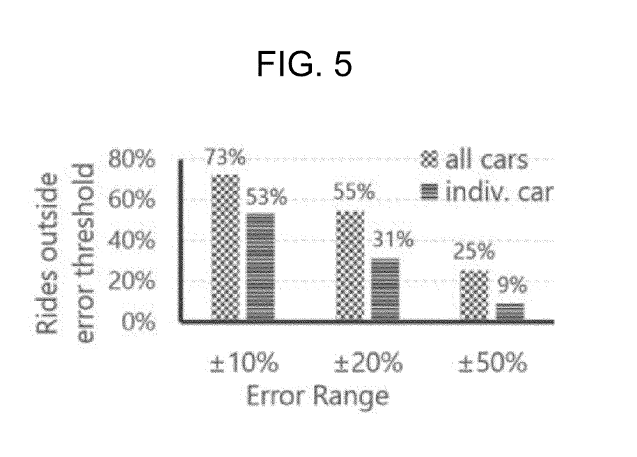

In many instances, several usable routes may exist between begin and end locations of a trip, and a route that a driver picks may impact fuel use. Further, even for the same route, varying congestion levels may also impact fuel use. The variation in fuel use may be greater where multiple vehicles are considered, due to different vehicle types and driving styles. FIG. 4 is a plot of a cumulative fraction of all rides versus the ratio of the fuel used in a ride to the average fuel used by all rides between the same begin and end locations. FIG. 5 shows the percentage of total rides that are off by more than given error thresholds of ±10%, ±20%, and ±50% from the average fuel used for all trips between the same pair of locations. Even when limited to trips for the same car and driver, FIG. 5 shows that 31% of trips are off by more than 20% of the average, and 9% of trips are off by more than 50% of the average. This illustrates that, even for the same car and route, fuel use may vary substantially. However, if accurate predictions were available, such predictions may indicate a particular route from among the different routes between a pair of locations that may reduce fuel use.

The disclosed examples may be conveniently implemented on a mobile computing device, such as a smart phone, or other suitable computing device. Referring again to FIG. 1, the depicted smartphone 100 is displaying a graphical user interface 102 for an application for estimating and/or predicting fuel usage by a vehicle. While graphical user interface 102 is illustrated as being displayed on a smartphone 100, it will be understood that any suitable computing device may be used.

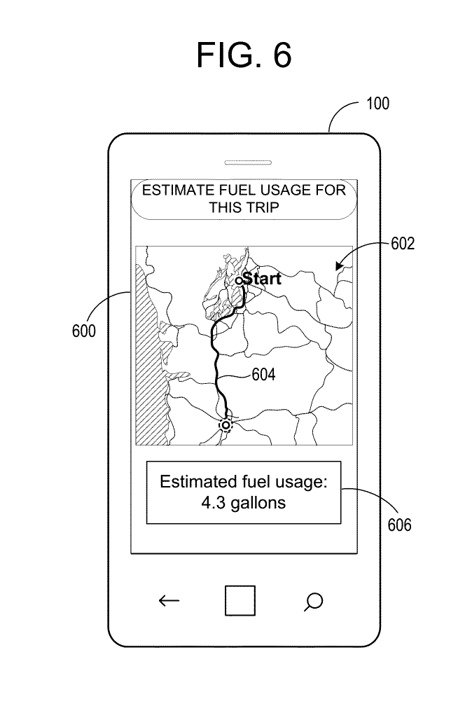

The graphical user interface 102 presents the option to predict fuel usage at 104 or to estimate fuel usage at 106. FIG. 6 depicts a fuel usage estimation graphical user interface 600 on smartphone 100 when a user has selected the estimate fuel usage option for a trip. Upon selection, the application may collect sensor data from the mobile computing device, and also OBD data from the vehicle if an OBD device is used. The user interface shows a map 602 depicting a route 604 traversed during a trip by a driver using the application (e.g. as determined from GPS sensor data gathered during the trip), and at 606 shows an estimated fuel usage by the vehicle that traversed the route. It will be understood that the graphical user interface of FIG. 6 is presented for the purpose of example and is not intended to be limiting in any manner.

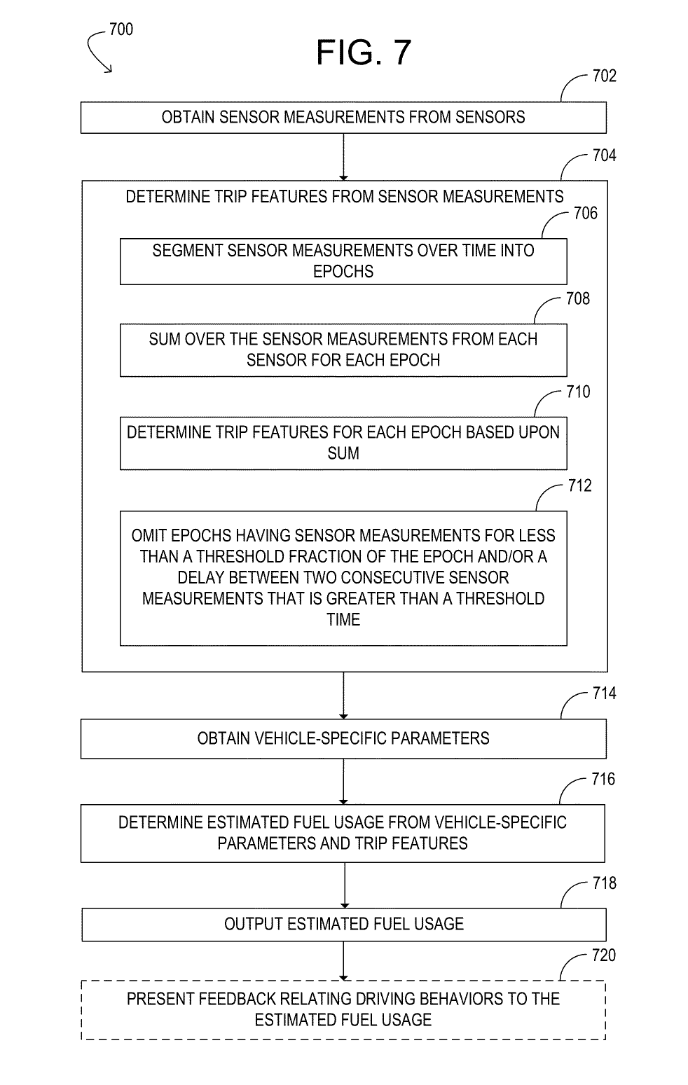

FIG. 7 shows a flow diagram illustrating an example method 700 for estimating fuel usage by a vehicle post-trip using mobile computing system sensor data acquired during the trip. Method 700 may be performed by a computing system, such as a smart phone, wearable device, or other mobile computing device, via machine-readable instructions stored on a machine-readable storage device. Example computing systems are described in more detail below.

Method 700 comprises, at 702, obtaining sensor measurements from one or more sensors. Sensor measurements may be obtained from sensors on a mobile computing device, on-board diagnostics device, and/or any other suitable device. As a more specific example, sensor measurements may be obtained via a mobile computing device, such as smartphone 100 or other suitable computing device that is located within a vehicle during a trip. In some examples, such a mobile computing device also may communicate with an OBD device to gather OBD data. Sensor measurements may be obtained from any suitable sensor(s). Examples of sensors that may be used on a mobile computing device include, but are not limited to a location sensor (e.g. a GPS sensor and/or altimeter), a motion sensor (e.g. an accelerometer and/or gyroscope) and/or any other suitable sensor. Likewise, any suitable sensor data that may be obtained via an OBD interface may be used.

Method 700 further comprises, at 704, determining a plurality of trip features from sensor measurements. The term “trip features” as used herein represents aspects of a trip that are measurable with sensor data, such that determination of the trip features may help to determine how the aspects of a trip may impact fuel consumption. More information on the nature of and determination of trip features (e.g. via processes 706-712 of FIG. 7) is presented below. Method 700 also comprises obtaining vehicle-specific parameters at 714, wherein the vehicle-specific parameters may include information that allow the determination of an estimated fuel use when applied to the trip features. Using this information, method 700 comprises determining an estimated fuel usage from the vehicle-specific parameters and the plurality of trip features at 716, and outputting the estimated fuel usage at 718.

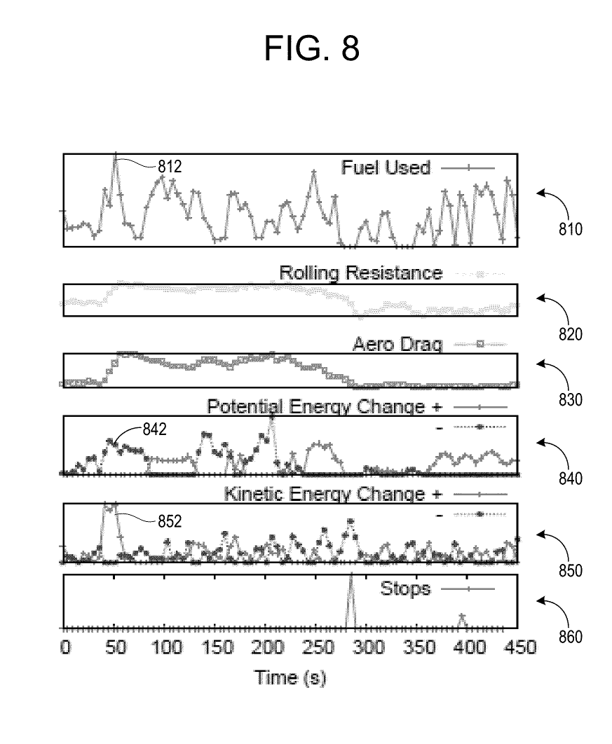

As mentioned above, the trip features represent aspects of a trip that are measurable with sensor data obtained from mobile computing device sensors and/or sensors that are incorporated into a vehicle, such as OBD sensors. Such trip features may be used in both estimating and predicting fuel use. As an illustration of factors that give rise to such trip features, FIG. 8 depicts various aspects an example trip from the experimental dataset of FIG. 3. In the trip represented by FIG. 8, a vehicle starts on surface roads, and then enters a highway on a downhill ramp and picks up speed after around 50 seconds (s). The highway goes up and down a sequence of hills from around 100-220 s, ending up at a lower elevation than that of where the driver joins the highway. At around 250 s, the driver exits the highway and stops at a traffic light. The remaining trip includes surface roads that gain elevation.

In FIG. 8, it can be seen that the instantaneous fuel used, shown at 810, varies during the course of the drive. The instantaneous fuel used starts at a low value as the driver starts on surface roads, and hits a first peak 812 when the driver increases speed to join the highway at 50 s, correlating with a peak 852 in kinetic energy change 850. Peak 812 has a relatively brief width, as the ramp that leads to the highway goes downhill, corresponding with a decrease 842 in potential energy change 840 at the time. It will also be noted that the energy to combat aerodynamic drag (which is proportional to the cube of velocity multiplied by time) and the energy to combat rolling resistance (which is proportional to velocity multiplied by time) are larger when the driver is on the highway from 50 to 250 s. Once the driver reaches highway speed, the fuel used goes up and down in sync with the highway elevation, as illustrated by corresponding changes in potential energy. At the stop at 250 s, fuel usage returns to a relatively smaller value. It can further be seen that on surface streets, the increases in fuel use track increases in both potential and kinetic energy, indicating that the streets have moderate changes in elevation and are associated with frequent changes in speed. Thus, FIG. 8 illustrates that fuel use may be a complex function of numerous factors, each of which may be dominant over other factors depending on the conditions.

Data such as that of FIG. 8, gathered for a road over time for a number of different drivers driving in different conditions, may be used to inform fuel use estimations, as well as predictions, for future traverses of that road. However, in some instances, no such information may be available for a road. In such instances, a road state model may be used to predict fuel use on roads for which no collected data is available. To construct a road-state model, map information may be obtained and used to infer aspects of the roads in a trip, based upon data for other roads having similar features. An example road state model is discussed in more detail below.

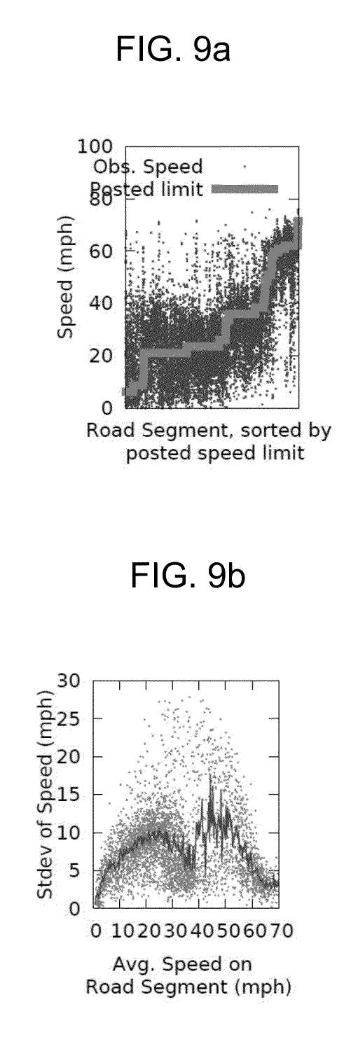

However, it may be difficult to infer useful information based upon the map information alone. For example, FIG. 9a shows a comparison of average speed on a road segment with the posted speed limit on that road segment. The data shows a correlation between actual speed on a segment and the posted speed limit, but there is substantial noise in the correlation, and also substantial variation in the speeds. FIG. 9b shows the standard deviation of speed versus the average speed per road segment for the data of FIG. 9a, and illustrates that the standard deviation is between 10 and 15 mph for most road segments. Variations in speed on a trip may impact fuel usage in numerous ways. For example, if a vehicle is accelerating and braking, the vehicle may use more fuel than a vehicle driving at a relatively constant speed, as more fuel may be used to increase kinetic energy on acceleration and/or be dissipated as heat on braking. Further, because aerodynamic drag is roughly cubic in velocity, using the average value instead of actual velocity can introduce significant error in fuel usage determinations.

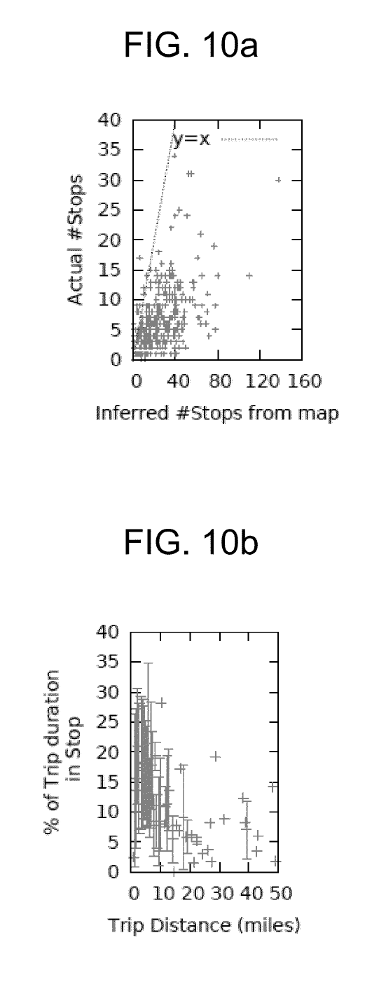

As another example of the difficulties that may be encountered in using map information alone to construct a road state model, FIG. 10a compares the actual stops observed in an example set of trips with the inferred number of stops from a map. In the example, the vehicle is considered to be stopped if the speed from GPS is below 5 mph. Not every stop on the map may correspond to an actual vehicle stop. For example, a traffic signal may be green, and thus may not correspond to a stop at various times. Also, in some instances, a vehicle may stop more often than would be indicated by a map, such as where traffic congestion causes additional stops. In the data set represented by FIG. 10a, the number of stops inferred from map data appears to be greater than the actual number of stops a majority of time, based on linear regression. Further, not every stop utilizes a similar amount of energy. For example, long stops and stops made on higher speed roads may have a greater effect on energy used, as more kinetic energy may be reclaimed after the stop. FIG. 10b shows a percentage of trip duration spent stopped versus a trip distance for the same example set of trips, and illustrates that, even among trips of similar length, the percentage of the trip duration that is spent in the stop state may be variable. The standard deviations are shown as error bars in FIG. 10b. As such, data from FIGS. 9a, 9b, 10a, and 10b indicate that the use of map information alone may lead to inaccurate estimates and/or predictions of fuel usage. Thus, as described in more detail below, data acquired from vehicles traversing the routes on the map (such as crowd-sourced data obtained via mobile computing device applications operated by vehicle owners while driving) may be applied to the map data to help obtain more accurate estimations and predictions.

Thus, it can be seen that fuel usage may be a complex function of many variables. For example, a grade of the road impacts change in potential energy as well as the rolling resistance at the wheel. A speed of the vehicle impacts changes in kinetic energy and also aerodynamic drag. Braking dissipates extra kinetic energy into heat. Vehicle-specific parameters, such as mass, impact both potential and kinetic energy. The vehicle's aerodynamicity further affects drag. Additionally, the engine and drivetrain efficiency impact the amount of useful energy generated from fuel usage. Also, driver-specific behaviors such as hard acceleration, hard braking, and manual transmission shifts also impact energy use. For example, during hard acceleration, the vehicle's fuel injection unit may have less time to modulate fuel injected, which may lead to relatively less energy used for an amount of fuel used. Further, miscellaneous aspects, such as windows being open, the temperature, use of air conditioning and other electrical equipment, may also affect fuel usage during a trip.

A vehicle energy model, as mentioned above, may capture some of these variables. In some examples, an instantaneous model of vehicular energy use may be used. For example, consider a small period time Δₜ, and suppose that a vehicle moves with velocity v on a road of grade θ, changes velocity by Δₜ, and burns fuel at a rate f. The instantaneous energy generated by the engine of the vehicle may be expressed as ηfΔₜ, where η is the engine specific fuel consumption and indicates the engine's efficiency in burning fuel. The energy generated by the engine is a function of torque and engine revolutions-per-minute (RPM). Slower speeds (lower RPM) and/or higher torque values may lead to lower η values. However, engines may have a large operating region where the engine's efficiency η is roughly the same, regardless of torque and RPM. For example, a combustion engine may have an efficiency of 30%, where roughly 30% of the heat produced by burning fuel is converted to mechanical energy.

Instantaneous mechanical energy at the engine may be expressed as τωΔₜ, where τ is the torque and ω is the RPM at the engine. The mechanical energy may be used in different ways. The energy spent may include, for example, energy spent at the wheel. Energy spent at the wheel may include energy to fight gravity, which may be expressed as mg[ sin θ]_{0|}vΔₜ, where m is the mass of the vehicle. Energy spent at the wheel may also include energy to fight rolling resistance, which may be expressed as cᵣᵣ mg[ cos θ] vΔₜ. This term may be based on visco-elasticity of the tire (the part touching the road bends) and the pressure differential in the tire due to movement. The coefficient of rolling resistance, cᵣᵣ, may be, as one non-limiting example, about 0.01 for radial tires on concrete, where cᵣᵣ may depend on v² and on road conditions (e.g. a three-fold difference in concrete versus sand). Energy spent at the wheel may further include energy to fight aerodynamic drag, which may be expressed as ½ c_{d} Apv³ Δₜ, where A is the effective frontal area of the vehicle and c_{d} is the drag coefficient. P is the density of air, and depends on temperature, altitude, and conditions like gusts. Energy spent at the wheel may further include energy to increased kinetic energy, which may be expressed as mg[Δᵥ]_{0|}.

Energy spent may also include energy spent in electrical components, which may be expressed as PₑΔₜ, where Pₑ is the electrical load induced by air conditioning and/or other car accessories. Energy spent may further include energy used when the vehicle is in standby, which may be expressed as IₛPₛΔₜ, where Pₛ is the power drawn to keep the engine in standby when the vehicle is stationary. Iₛ is an indicator variable denoting if the vehicle is in standby, for example, Iₛ may be set to equal 1 if v<5 miles per hour.

Energy spent may further include the energy in drivetrain loss, ηₜ. This term denotes the fraction of the engine's energy that is delivered to the wheel by the transmission system. For instance, ηₜ may range from 94% efficient for manual transmissions to 70% for automatic transmissions. The ηₜ over a ride may depend on the number of gear shifts during a ride. For example, gear shifts needed for maintaining speed on a flat road may vary greatly from gear shifts needed for frequent starts and stops.

While the above examples describe variables associated with energy spent, energy may also be lost. Energy loss in potential energy while going down a slope, for example, may be expressed as mg[ sin θ]₀₋vΔₜ. Energy loss in kinetic energy while slowing down, for example, may be expressed as mg[Δᵥ]₀₋. As a specific example, a driver may slow down a vehicle without braking, thereby letting the loss in kinetic energy compensate for rolling resistance and aerodynamic drag. While an increase in potential or kinetic energy may require burning fuel, a loss in potential or kinetic energy may not be fully recovered. For example, braking may dissipate kinetic energy into heat. Thus, some recovery factors (R₁, R₂) may be assumed based on whether the changes in energy are increases or decreases.

Using all of the energy components as described above, a relationship may be expressed as follows.

Energy generated+Recovered=Energy used.

Using this and rearranging terms, the relationship may be further expressed as:

$$\begin{matrix}η f {Δ}_{t} = τ {ωΔ}_{t} \\ = {P}_{e} {Δ}_{t} + {P}_{s} {I}_{S} Δ t + \\ \frac{{mg [ sin θ ]}_{0 +} v {Δ}_{t} + {mv [ {Δ}_{t} ]}_{0 +}}{{η}_{t}} + \\ \frac{{c}_{rr} mg cos θ v {Δ}_{t} + \frac{1}{2} {c}_{d} A ρ {v}^{3} {Δ}_{t}}{{η}_{t}} + \\ {R}_{1} {mg [ sin θ ]}_{0 -} v {Δ}_{t} + {R}_{2} {mv [ {Δ}_{v} ]}_{0 -}\end{matrix}$$

A vehicular energy model based upon the above equation relates fuel use (left of equation) to measurable aspects of the trip and some parameters (right of equation). As mentioned above, these measurable aspects of a trip may be referred to as trip features. Trip feature values may be obtained from mobile computing device sensor readings, and/or by applying a road state model to information from a map. When using phone readings, a sum, or integral, may be computed over the instantaneous reading rather than using an average observed value, which may help to avoid errors due to variations.

Table 2 lists an example set of trip features that may be used to estimate energy use.

TABLE 2
Trip features that may help with estimating energy use

| Trip feature | How computed |
|---|---|
| Energy from burning fuel | Σ fΔₜ |
| Energy generated by engine | Σ τωΔₜ |
| Change in kinetic energy, +′ve (and −′ve) | Σ v[Δᵥ ]₀₊ |
| Change in potential energy, +′ve (and −′ve) | Σ [sinθ]₀₊ vΔₜ |
| Aerodynamic drag | Σ v³Δₜ |
| Rolling resistance | Σ cosθvΔₜ |
| Standby | Σ IₛΔₜ |
| Miscellaneous | Σ Δₜ |
| Supporting | Σ v²Δₜ |
| | Σ vΔₜ |

In Table 2, the values in the right column are a multiplicative parameter away from the corresponding energy term on the left in the vehicular energy model. These coefficients may be learned from training data. Though the coefficients may be specific to a car, the coefficient may still vary from one trip to another. For instance, a vehicle's mass m increases when carrying passengers or towing. In some examples, a mobile device application for estimating and/or predicting fuel use may allow information regarding the vehicle occupancy to be entered into a fuel use model.

The first two features in Table 2 may be available when an OBD device is installed, while all others may be available from sensors readings off a smartphone and map-matching with a map. Thus, an OBD device may be used to obtain ground truth in training, while sensor readings may be used to examine the value of additional sensor data that is available from OBD. The features labeled “Supporting” in Table 2 may be used to compensate for incorrect readings and for the limited sampling frequency of phone sensors. For example, velocity data as determined form GPS may have a sample rate no faster than one sample per second in some instances), as discussed in more detail below.

Table 3 below summarizes the sources of raw data and how sensor readings may be obtained for the purpose of computing trip features from sensor data.

TABLE 3
Sources of raw data used to obtain readings

| Source | Raw data inputs |
|---|---|
| OBD | f = fuel injection rate |
| (on-board diagnostics) | v = vehicular speed |
| | ω = RPM |
| | τ = torque |
| GPS | l = location [lat, long] |
| | v^{g} = speed |
| | course and accuracy |
| Map | θ = slope per road segment |
| | stop locations |
| Vehicle Parameters | m = mass |
| (car itself + training data) | A = effective area |
| | H = engine's efficiency |

Given raw data that may be observed at different times (and frequencies), trip feature values may be computed that are joint functions of the raw values. However, computing such values may pose difficulties, as observed raw values may be highly variable. For example, the grade of the road may change many times between successive velocity readings form GPS, the fuel sensor readings may have been sampled three times for every sample of velocity, and further some samples may be missing and none of the sampled times may match.

Thus, returning FIG. 7, to address such issues, various time series may be composed by extracting feature values over epochs, which are fixed-size non-overlapping intervals of time. This is illustrated in FIG. 7 at 706. The epochs may be sized such that each time series is observed at least a few times per epoch. Sensor readings may be transformed into piece-wise linear functions of time by assuming that the functions change at some fixed rate between subsequent readings. For example, if the ith velocity reading at time tᵢ is vᵢ, then the velocity at t may be estimated as

$$v ( t ) = {v}_{i} + \frac{t - {t}_{i}}{{t}_{i + 1} - {t}_{i}} ( {v}_{i + 1} - {v}_{i} ) if t ε [ {t}_{i} , {t}_{i + 1} ] .$$

Similar functions for each of the relevant readings (v, θ, l, f, ω, τ) may also be computed. Then, by summing (e.g. by integrating) over the piece-wise linear functions of the corresponding readings, as shown in FIG. 7 at 708, the value of a feature in an epoch may be determined based upon the sum, as shown at 710. For example, for an epoch lasting from t_{b} to tₑ, the rolling resistance feature may be computed as ∫ₜ_{_{b}}^{t}^{ₑ} cos(t) v(t) dt.

In some implementations, when computing feature values based on the GPS sensor, v(t)dt may be substituted with l(t+dt)−l(t), where l(t) is the interpolated geographic location at time t. This may help to avoid accumulating errors (even small errors) in estimating the velocity over time. Similarly, it may be desirable to avoid integrating over a rate if the underlying value is available.

Because many of the readings are rates (e.g. f is fuel injection rate), interpolating missing readings or holes based on the values at the ends may have relatively large error. Thus, instead of interpolating, such error may be avoided or lessened by using epochs that have no data missing (holes) for larger than a given threshold of the epic and/or that have observations for at least a threshold fraction of the epoch, as shown in FIG. 7 at 712. As one non-limiting example, for GPS readings, readings with location error of less than 50 meters may be considered and others with a greater error excluded, for example. Further, the observed feature values may be scaled to span the entire epoch. For instance, if readings of the rolling resistance feature are only available for 80% of the epoch, the missing part or hole may be assumed to have the same overall behavior, and the value of the feature scaled up by one eighth. In this manner, trip features may be computed from sensor readings.

As mentioned above, vehicle-specific parameters may be applied to determined trip features to obtain estimated or predicted fuel use. Vehicle-specific parameters may be determined in any suitable manner For example, in some implementations, trip features and fuel usage data gathered from OBD as described above may be used to learn vehicle-specific parameters relating the trip features to the fuel usage. Such learning may include, but is not limited to, linear regression, non-linear regression with the underlying raw readings, a classifier that uses discretized fuel usage as a label, and/or decision trees. To keep parameters robust, additional training data may be created by combining features from contiguous epochs to represent the features in larger variable sized epochs. Thus, parameters may be used with trip features computed on epochs of any suitable duration.

For the purpose of estimating fuel use, vehicle-specific model parameters may be learned, for example, by collecting OBD data and other sensor data described above for a specific car over a period, of time, e.g. a few days. Then, on subsequent drives, the vehicle-specific model parameters learned may then be applied to the trip features computed over the phone sensor readings to yield an estimate of fuel use, even without the use of the OBD device. Further, the features may be used to compare driving behavior with other drivers or to provide feedback, as discussed in more detail below.

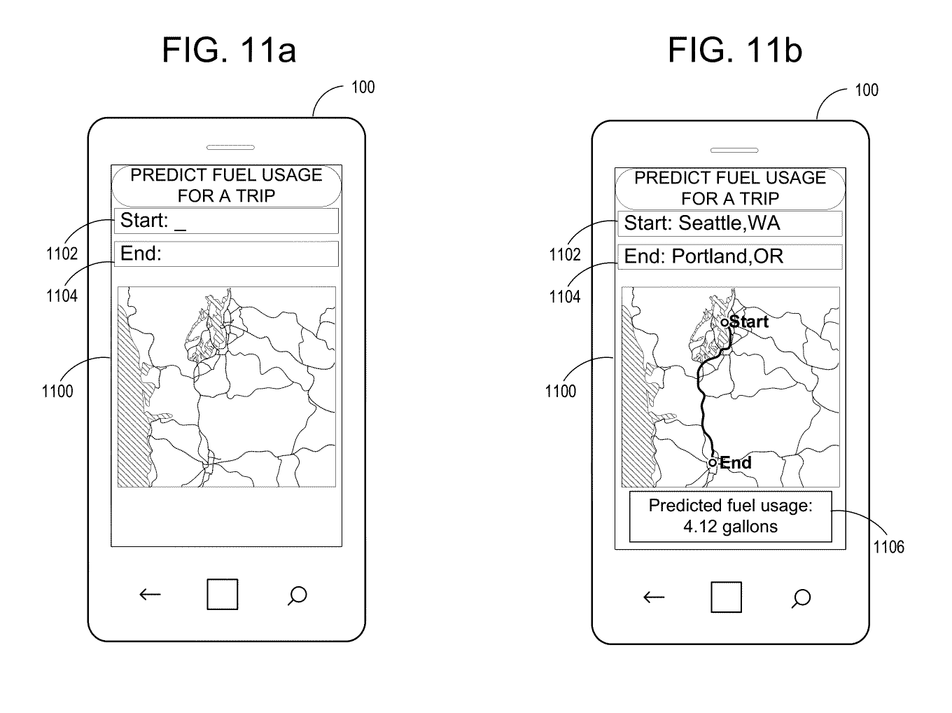

The examples disclosed above also may be used in fuel use prediction. FIGS. 11a and 11b show an example user interface 1100 displayed upon selection of the fuel usage prediction option of the user interface of FIG. 1. As depicted in FIG. 11a, the user interface may allow input of start and end locations of a trip at 1102 and 1104, respectively. In some examples, other input fields may be available, such as how many passengers will be in vehicle, how much extra weight the vehicle will be carrying, etc. In FIG. 11b, user interface 1100 shows an example predicted fuel usage at 1106 after the user has entered start and end location information.

Predicting fuel usage may present challenges, as neither the vehicle-specific parameters nor the trip features may be available a priori. However, various methods may be used where this information is not available. For example, trip features from prior trips on a same route may be available. However, prior trip features from the same driver may be somewhat different due to traffic congestion and other factors. Likewise, features from other drivers may also include differences due to driving styles, for instance. As such, appropriate correction may be applied, such as for current traffic conditions (actual from real-time map information or estimated based upon patterns, such as time of day), and/or for different driving styles (e.g. as determined from prior driving behaviors).

However, in some instances, a driver may wish to predict fuel use for a road for which no prior trip data is available (e.g. where no user of a fuel use estimation and/or prediction system has provided OBD data for the road). In such instances, given trip feature data for a large number of roads, the features of a new, untraversed road may be estimable by using data from similar roads. For example, the change in kinetic energy on a 50 m long road segment with a 30 mph posted speed limit having 2° grade and no stops during rush hour may be likely similar to another road segment having a similar length, speed limit, grade and congestion patterns.

Thus, as mentioned above, road features may be computed for road segment with no actual trip feature data using mapping information. Table 4 lists example road features that may be determined for a road segment.

TABLE 4
Road features that may help with predicting fuel usage

| Road feature | How determined |
|---|---|
| Road length | x from map |
| Road speed limit | v, v² from map |
| Road grade | θ from map |
| Road rolling resistance | xcosθ |
| Road change in potential energy, +′ve (and −′ve) | x[sinθ]₀₊ |
| Road aerodynamic drag | xv² |
| Road rush hour velocity multipliers | rᵥ, rᵥ² |
| Road number of stops | s |

Determined road features then may be used to determine trip feature values, as described above. However, instead of per epoch, the trip features may be computed per road segment. Then, a model may be trained for each of the trip features that relates the road feature values to the value of the trip feature. This model may be referred to as the road state model.

Direct estimation may be possible for a few trip features, and the road state model may be used to estimate others. For example, the rolling resistance of a trip ∫cos θ v dt may be directly estimated as the sum over the road segments in the trip, wherein the rolling resistance is Σ×cos θ. In contrast, change in kinetic energy depends on the actual changes in the velocity of a vehicle, which may not be known prior to a trip. Further, some features such as aerodynamic drag may appear directly estimable, but may be more robustly estimated by the road state model, as such features may depend on the actual velocity values rather than posted speed limit.

Using the information above, fuel usage may be predicted for a new trip on roads for which no prior trip data is known by computing the road features for each road segment on the trip, applying the road state model to compute trip features and summing over the per segment contributions, and applying the vehicular energy model (e.g. using vehicle-specific parameters). It is possible that errors in computing trip features from road features may be carried through and amplified when estimating fuel use from trip features. Accordingly, the road state model may be augmented to account for potential inaccuracies. As one example, a set of coefficients may be learned when going from the estimated trip feature values to the fuel usage value. The road state models may optimize locally, such that the models attempt to closely mimic a given trip feature. The coefficients may help to globally merge these local values. The resultant model may remain linear, such that the global coefficients are constant multipliers to the underlying road state models.

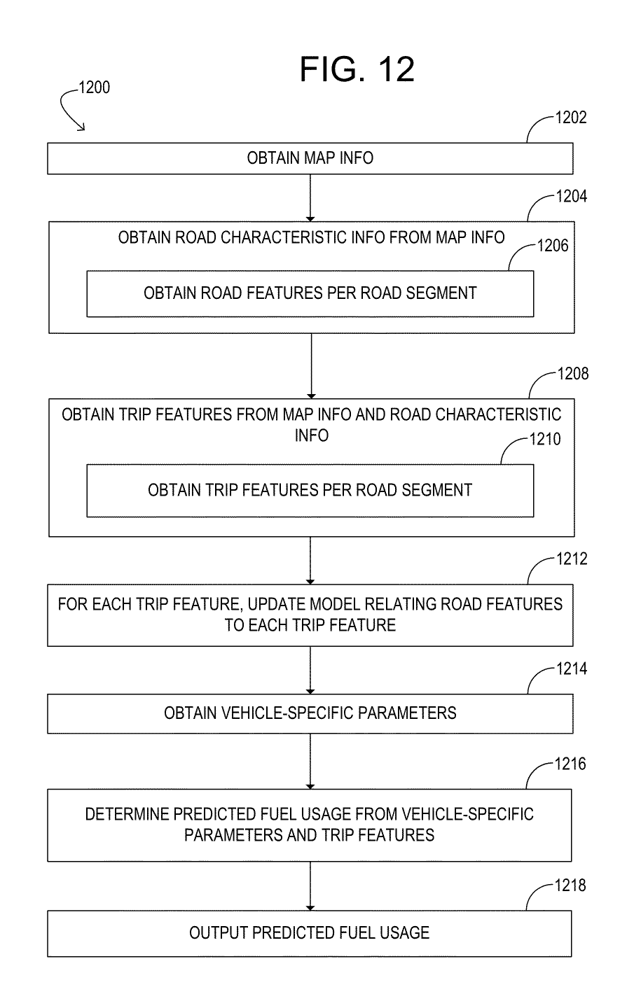

FIG. 12 shows an example method 1200 for predicting fuel usage. Method 1200 comprises obtaining map information at 1202, obtaining road characteristic information from the map information at 1204, including obtaining road features per road segment at 1206. Method 1200 further comprises obtaining trip features from the map information and road characteristic information at 1208, including obtaining trip features per road segment at 1210. Method 1200 further comprises, for each trip feature, updating a model relating road features to each trip feature at 1212.

Method 1200 further comprises obtaining vehicle-specific parameters at 1214. Such parameters may comprise parameters determined from training data gathered from a number of cars of a same make, model, and/or year, or may be estimated without any training data from that vehicle. As one example, vehicle-specific parameters may be estimated from automobile specifications (e.g. mass, rolling resistance coefficient cᵣᵣ, efficiency η, etc.). As another example, vehicle-specific parameters may a car may be inferred based on those of similar cars. or obtained in any other suitable manner Method 1200 further comprises, at 1216, determining predicted fuel usage from vehicle-specific parameters and trip features, and at 1218, outputting the predicted fuel usage.

As mentioned above, an OBD device in a vehicle may be used to obtain ground truth data to train a fuel usage estimation and/or prediction model. Ground truth data may be obtained in any suitable manner. As one non-limiting example, in an experiment to obtain ground truth data, vehicular information was obtained by installing devices that plug into the OBD port in vehicles of volunteers. Vehicles sold in the U.S. after 1996 are required to have an OBD port, which may be found underneath the steering assembly. Further, a smartphone application was built that connects to the OBD device via Bluetooth and queries the engine control unit of the vehicle. The Parameter Identification Number (PID) in the query identifies the information requested (e.g., 010 D for speed). Vehicle manufacturers may implement several proprietary PIDs, but to be broadly applicable the application may rely on the PIDs in the OBD-II standard. Some vehicles may not have the sensors utilized by some PIDs. For example, some models may lack a fuel injection sensor. Further, sensor values may update at different timescales, and queries on some vehicles, such as older cars, may take significantly longer (e.g. 10×) the time scale of queries on other vehicles. In view of these variations, the application may first sweep the PID space to identify PIDs for a vehicle that offer non-trivial responses and determine the frequency at which they update. Then, the application may generate a polling schedule such that the more relevant PIDs (e.g., speed, RPM, torque, fuel) are polled at a suitable rate, for example, at least once every few seconds. Polling all standard PIDs in a round-robin manner may retrieves comparatively less information than this approach.

An application for gathering training data may have any suitable features. For example, it may be desirable for the application to run continuously in the background and collect data whenever in a moving vehicle, or else the application may miss rides and/or drain the battery. Further, the application may be configured to have low power consumption. For instance, assuming that a user may drive a car for less than two hours a day, the application may be configured to cost less than 10% of the day's power draw for two hours of data collection and 22 stationary hours. As yet another example, to preserve a volunteer's privacy, the application may allow data scrubbing of personally identifiable information such as location of homes and destinations. Further, the application may allow for other Bluetooth connections, such as that of the vehicle headsets or car speakers, concurrently with that of the OBD connection by utilizing a different Bluetooth profile than such other devices.

Map information may be obtained in any suitable manner from any suitable source. As a non-limiting example, map information may be obtained from an open source, and/or from a proprietary vendor. Map-matching from GPS location readings may help to identify a most likely path along road segments for a trip.

In the evaluation of the fuel usage models, trip data was collected from unconstrained drivers. Per trip, the error in estimating and predicting fuel usage was measured as follows:

$$relative error = 100 \times \frac{estimate - actual}{actual}$$

When the sign of the error was not relevant, the absolute value of the relative error was used.

Per driver and given a collection of trips, contribution to fuel usage by each of several components was computed. Such components included rolling resistance, increasing potential energy, increasing kinetic energy, aerodynamic loss, idling and other components. The net positive contribution from the decreases in potential and kinetic energy was also estimated, as, for example, rolling downhill may utilize less fuel to maintain speed, or a driver may slow down without braking by losing kinetic energy to aerodynamic drag.

Options may exist in how the vehicle-specific parameters are obtained, how the trip features are obtained, and/or how these are combined. As such, several variations were assessed in the experiment. For example, OBD features and Phone features refer to trip features computed post-facto based on sensor readings from the corresponding device (see Table 2). OBD features may include features not obtainable by phone sensor readings, such as the torque and RPM at the engine. Road features refers to trip features computed based on information from a map (see Table 4). Road→Phone features refer to trip features computed pre-facto based on applying the road state model to road features as described above.

OBD model and Phone model refer to the vehicle-specific parameters that relate fuel usage to OBD features and Phone features, respectively. For both models, the parameters are learnt as described herein from training data. Plain model refers to vehicle parameters from automobile specifications.

Not all of model+feature combinations may be useful. P1R refers to applying the Plain Model on the Road features. PIR may serve as a baseline, as PIR uses no models and thus may be used for prediction and post-facto estimates. OO refers to applying the OBD model on OBD features. The OO combination may be expected to have a relatively smaller error. PhPh refers to applying the phone model on phone features. Both OO and PhPh are usable post-facto after the drive, since the features are not available a priori. PhRPh refers to applying the Phone model on Road→Phone features, which may be usable for prediction.

After completing a trip, measuring the amount of fuel consumed during the trip may be of value to a driver. For example, the driver may estimate how much emissions his/her driving caused. It may be especially useful when the tank is nearly empty.

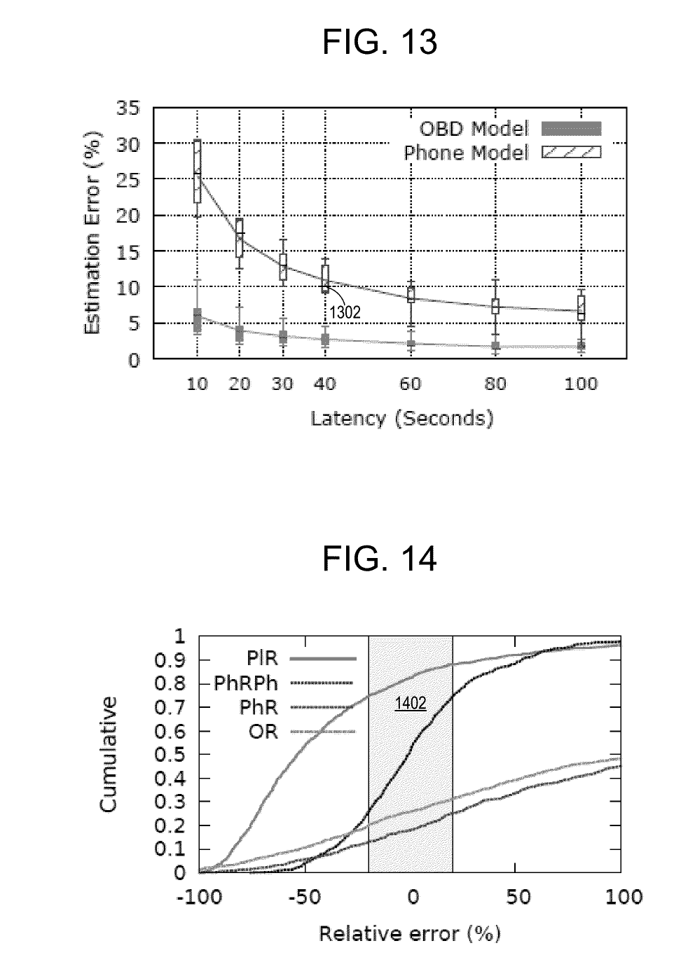

FIG. 13 plots the absolute value of estimation error versus the duration over which the estimate was computed using data from an OBD device and mobile device, and from the mobile device alone. For each vehicle, the average error was computed over all non-overlapping contiguous traces of a given duration. The error bars 1302 show the minimum and maximum and their quartiles for estimation error values across drivers. Most trips last over 100 seconds. In FIG. 13, PhPh yields an average error of 7%. All the cars have less than 10% error. Comparatively, OO has a smaller error, 2% at 100 seconds and just 6% for 10 second intervals. As mentioned above, if an OBD device is installed, the fuel usage may be directly available. Thus, the error of OO was computed to evaluate the models. Based on the data obtained, for most trips, fuel use may be estimated from mobile device sensor data, without the use of OBD data.

The ability to predict fuel usage was also evaluated. In the dataset, a large fraction of the trips taken by the drivers involve road segments for which no prior trip data was available. FIG. 14 depicts the relative error for a few predictive schemes. PhRPh first uses the road state model to convert Road features (from a map) to Phone features, to which it then applies the Phone model. For 49% of the trips, the predictions of fuel usage were within 20% error, as shown by the gray region 1402 in FIG. 14. The fraction of trips that can be predicted to within 20% error for the baseline (PIR), for PhR (applying Phone model on Road features), and for OR (applying OBD model on Road features), are 13%, 11% and 12%, respectively. Thus, for PhRPh, about four times more trips can be predicted to within 20% error. This may arise from the use of crowd-sourced data in the PhRPh scheme to learn a method that estimates aspects relevant to fuel consumption based upon detectable features of roads

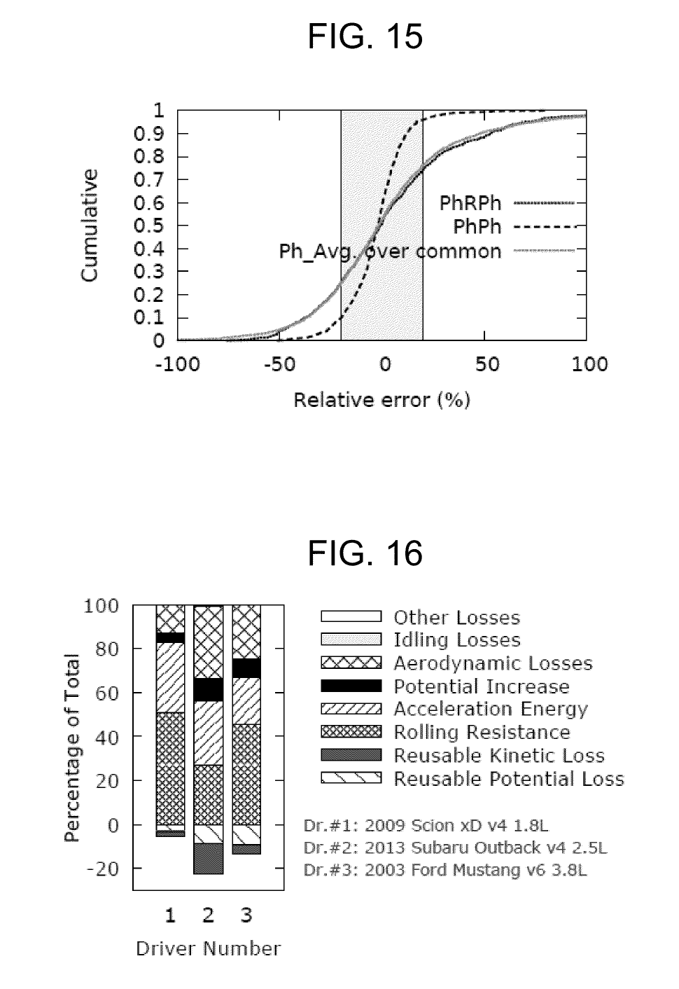

FIG. 15 compares the experimentally determined best predictive scheme PhRPh with two alternatives. “Ph_Avg. over common” applies the phone model to the average Phone features from other cars that traversed common road segments. In the dataset, while most trips have some common segments, the trips are dominated by road segments not traversed by any other car. As such, the “Ph_Avg. over common” scheme has a small coverage (the fraction of road segments that we could predict fuel for). Looking at just the common segments, “Ph_Avg. over common” is only marginally better than PhRPh. Attempts to improve “Ph_Avg. over common” by only using phone features from similar cars further reduced coverage. While the “Ph_Avg. over common” scheme may perform well if more data from more cars were available, PhRPh may be more suitable when a small amount of crowd-sourced data is available. In FIG. 15, the PhPh performs better than PhRPh: 86% of the trips are within 20% error, indicating that there is room to improve predictions further. However, PhPh requires phone features acquired during driving, and thus may not be used for pre-drive prediction.

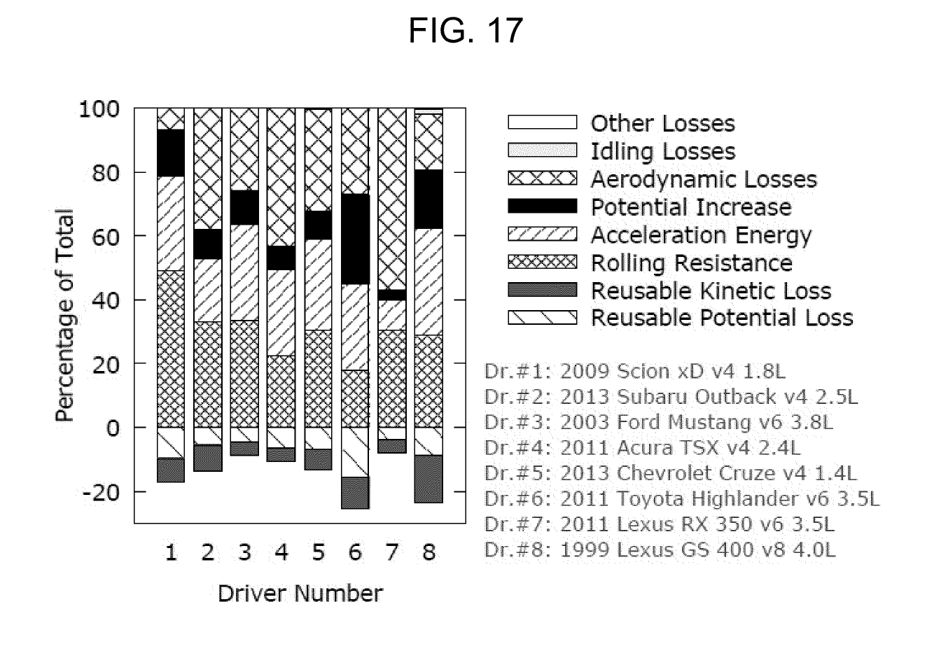

Crowd-sourcing data collected from the application may allow for observing how different drivers traverse the same road segments. As such, crowd-sourcing data may compare driving behaviors across drivers. The feedback may help highlight potential poor driving practices or opportunities to reduce emissions. To illustrate the value of such analysis, FIG. 16 plots the per-component contributions of three drivers. The plot uses the portion of their trips that traversed road segments that the other drivers also traversed. The results here are obtained from the PhPh combination unless otherwise noted. In FIG. 16, driver #2 has high aerodynamic losses. This may arise from a car having a larger frontal area than the others. Further, we see that driver #2 appears to take advantage of kinetic energy loss. For example, rather than braking hard, driver #2 may be letting the car slow down by counteracting aerodynamic drag and rolling resistance. In contrast, the other drivers may benefit by less aggressive braking or braking less often. Rolling resistance is large for driver #1 even though the corresponding car weighs the least and may be expected to have the smallest rolling resistance. Recall that rolling resistance may be expressed as mg ∫cos θ v dt, and the integral value is essentially the same for a given sequence of road segments since ∫ v dt is the sum of segment lengths. This may indicate that driver #1 may be using older tires or may need to optimally inflate her tires.

Analyzing all the data from a given car may reveal further insights specific to driving behavior. FIG. 17 plots the per-component contributions for eight drivers. Consider driver #6, who has a large hybrid SUV. The daily commute of driver #6 involves climbing a steep hill near her residence; consequently driver #6 spends the most fuel in going uphill (potential increase). Driver #6 is able to make more use of the loss in kinetic energy (KE) because the car explicitly recaptures what would otherwise be lost as heat upon braking to charge the battery instead. In contrast, driver #8 does not have a hybrid but appears to be by far the gentlest user of brakes, thus reducing kinetic energy by making it work against the other losses. For driver #7, who also has a large SUV but primarily uses it to commute from a suburb to the city on a major highway, rolling resistance and aerodynamic losses dominate. This may be expected, as most of driver 7's driving occurs at higher speeds, involves long distances, and is done in a car having a large frontal area. Comparatively, driver #7 spends less fuel in increasing KE (acceleration energy), hinting that most drives are at relatively steady velocity. Further, there is not much change in PE for driver #7, because the trips are in the Midwest, and on flat roads. Next consider driver #4, who has a smaller wagon and also mostly commutes on a congested highway. The component breakdown of driver #4 is similar to that of driver #7 except for a larger contribution due to increasing KE. Traffic congestion may cause driver #7 to change speed often. In contrast, driver #1 uses a sub-compact for a long commute and some errands on surface streets. We see that rolling resistance is dominant for driver #1, while aerodynamic drag is small due to the slower speeds and small frontal area.

Thus, the fuel usage estimation/prediction examples disclosed herein may allow fuel usage to be estimated and/or predicted by sensors on a mobile computing device via a modeling of actual energy changes that occur when driving. Such examples may provide a more granular analysis of a trip than simply applying an EPA MPG figure to a distance of the trip. Such analyses also may allow for comparisons of driving behaviors during a trip, as well as comparative analyses of different drivers traversing a same route.

In some embodiments, the methods and processes described herein may be tied to a computing system of one or more computing devices. In particular, such methods and processes may be implemented as a computer-application program or service, an application-programming interface (API), a library, and/or other computer-program product.

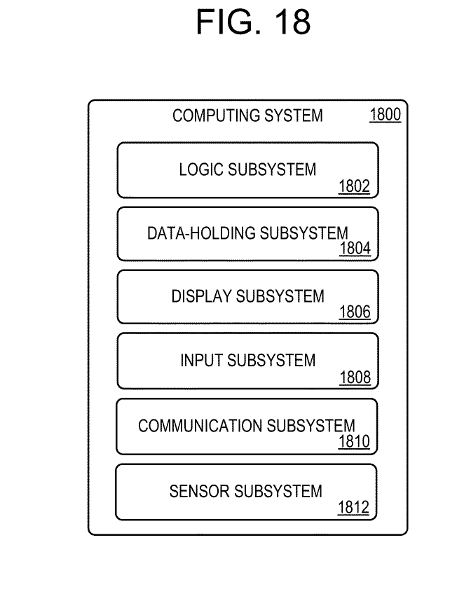

FIG. 18 schematically shows a non-limiting embodiment of a computing system 1800 that can enact one or more of the methods and processes described above. Computing system 1800 is shown in simplified form. Computing system 1800 may take the form of one or more personal computers, server computers, tablet computers, home-entertainment computers, network computing devices, gaming devices, mobile computing devices, mobile communication devices (e.g., smart phone), and/or other computing devices.

Computing system 1800 includes a logic subsystem 1802 and a data-holding subsystem 1804. Computing system 1800 may optionally include a display subsystem 1806, input subsystem 1808, communication subsystem 1810, sensor subsystem 1812, and/or other components not shown in FIG. 18.

Logic subsystem 1802 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Logic subsystem 1802 may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Data-holding subsystem 1804 includes one or more physical devices configured to hold instructions executable by the logic machine to implement the methods and processes described herein. When such methods and processes are implemented, the state of data-holding subsystem 1804 may be transformed—e.g., to hold different data.

Data-holding subsystem 1804 may include removable and/or built-in devices. Data-holding subsystem 1804 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Data-holding subsystem 1804 may include volatile, nonvolatile, dynamic, static, read/write, read-only, random-access, sequential-access, location-addressable, file-addressable, and/or content-addressable devices.

It will be appreciated that data-holding subsystem 1804 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 1802 and data-holding subsystem 1804 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 1806 may be used to present a visual representation of data held by data-holding subsystem 1804. This visual representation may take the form of a graphical user interface (GUI). As the herein described methods and processes change the data held by the storage machine, and thus transform the state of the storage machine, the state of display subsystem 1806 may likewise be transformed to visually represent changes in the underlying data. Display subsystem 1806 may include one or more display devices utilizing virtually any type of technology. Such display devices may be combined with logic subsystem 1802 and/or data-holding subsystem 1804 in a shared enclosure, or such display devices may be peripheral display devices.

When included, input subsystem 1808 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1810 may be configured to communicatively couple computing system 1800 with one or more other computing devices. Communication subsystem 1810 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1800 to send and/or receive messages to and/or from other devices via a network such as the Internet.

Sensor subsystem 1812 may comprise or interface with one or more sensor devices, including but not limited to one or more location sensors, such as a GPS sensor, one or more motion sensors, such as one or more accelerometers and/or gyroscopes, and/or any other suitable sensors. Further, sensor system 1812 also may include or interface with vehicular sensors that are a part of an on-board diagnostic (OBD) system for a vehicle. Sensor system 1812 may interface with external sensors in any suitable manner, whether by wired or wireless protocol.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

Another example provides a method, on a computing device, for predicting fuel usage for a vehicle, the method comprising obtaining map information for a trip having a route, obtaining road characteristic information for the route from the map information, the road characteristic information defining road features for the route, obtaining a plurality of trip features from the map information and road characteristic information, the plurality of trip features comprising effects of the road features on a vehicle traveling the route, obtaining vehicle-specific parameters for the vehicle, determining a predicted fuel usage for the trip from the vehicle-specific parameters and the plurality of trip features, and outputting the predicted fuel usage. The method may alternatively or additionally include obtaining road characteristic information by obtaining the road features for each road segment of a plurality of road segments for the route and obtaining the plurality of trip features for each road segment. The method may alternatively or additionally include, for each of the plurality of trip features, updating a model relating the road features to each trip feature. The road features may alternatively or additionally include one or more of a road length, a road speed limit, a road grade, a road rolling resistance, a road change in potential energy, a road aerodynamic drag, rush hour velocity multipliers, and a number of stops. The plurality of trip features may alternatively or additionally include one or more of an energy from burning fuel, an energy generated by an engine of the vehicle, a change in kinetic energy, a change in potential energy, an aerodynamic drag, a rolling resistance, and a standby energy. The vehicle-specific parameters may alternatively or additionally include one or more of a vehicle mass, a frontal effective area, and an efficiency of an engine of the vehicle. The method may alternatively or additionally include obtaining vehicle-specific parameters from vehicle specifications. Any or all of the above-described examples may be combined in any suitable manner in various implementations.

Another example provides a machine-readable storage device comprising instructions executable by a mobile computing device to estimate fuel usage by a vehicle during a trip by obtaining sensor measurements from one or more sensors of the mobile computing device during the trip, determining a plurality of trip features from the sensor measurements, each trip feature representing an aspect of one or more of energy produced and energy consumed during the trip, obtaining vehicle-specific parameters of the vehicle, determining an estimated fuel usage from the vehicle-specific parameters and the plurality of trip features, outputting the estimated fuel usage, and presenting feedback relating driving behaviors of a driver of the trip to the estimated fuel usage for the trip. The instructions may alternatively or additionally be executable to segment the sensor measurements over time into epochs, wherein a duration of each epoch is sufficient to include a plurality of sensor measurements from each sensor, sum over the sensor measurements from each sensor for each epoch, wherein the sum is performed based upon a fixed rate change between consecutive sensor measurements for each sensor, and determine the plurality of trip features for each epoch based upon the sum. The instructions may alternatively or additionally be executable to omit epochs having sensor measurements for less than a threshold fraction of the epoch and to omit epochs having a time difference between two of the consecutive sensor measurements larger than a threshold time. The plurality of trip features may alternatively or additionally include one or more of an energy from burning fuel, an energy generated by an engine of the vehicle, a change in kinetic energy, a change in potential energy, an aerodynamic drag, a rolling resistance, and a standby energy. The sensor measurements may additionally or alternatively include one or more of a vehicular speed, a location of the vehicle, a slope of a road segment of the trip, a fuel injection rate, an engine revolutions-per-minute speed, and a torque. The vehicle-specific parameters may alternatively or additionally include one or more of a vehicle mass, a frontal effective area, and an efficiency of an engine of the vehicle. The instructions may alternatively or additionally be executable to learn the vehicle-specific parameters from a relationship between the plurality of trip features and the estimated fuel usage. The instructions may alternatively or additionally be executable to present comparative feedback comprising the feedback for the driver compared to additional feedback for a second driver, the additional feedback comprising relation of driving behavior of the second driver to a second estimated fuel usage for the second driver. Any or all of the above-described examples may be combined in any suitable manner in various implementations.

Another example provides a mobile computing device comprising a logic subsystem, a data-holding subsystem comprising instructions executable by the logic subsystem to estimate fuel usage by a vehicle during a trip by obtaining sensor measurements from one or more sensors of the mobile computing device during the trip, determining a plurality of trip features from the sensor measurements, each trip feature representing an aspect of one or more of energy produced and energy consumed during the trip, obtaining vehicle-specific parameters of the vehicle, determining an estimated fuel usage from the vehicle-specific parameters and the plurality of trip features, and receiving from an on-board diagnostics device information related to a current energy generated by an engine of the vehicle, determining an estimated fuel usage from the vehicle-specific parameters and the plurality of trip features, outputting the estimated fuel usage, and presenting feedback relating driving behaviors of a driver of the trip to the estimated fuel usage for the trip. The instructions may alternatively or additionally be executable to obtain the sensor measurements from the on-board diagnostics device and to update a function of the mobile computing device to learn the on-board diagnostics device information based upon the sensor measurements obtained from the on-board diagnostics device. The on-board diagnostics device information may alternatively or additionally include one or more of a fuel injection rate, a vehicular speed, an engine revolutions-per-minute speed, and a torque. The plurality of trip features may alternatively or additionally include one or more of an energy from burning fuel, an energy generated by an engine of the vehicle, a change in kinetic energy, a change in potential energy, an aerodynamic drag, a rolling resistance, and a standby energy. The instructions may alternatively or additionally be executable to present comparative feedback comprising the feedback for the driver compared to additional feedback for a second driver, the additional feedback comprising relation of driving behavior of the second driver to a second estimated fuel usage for the second driver. Any or all of the above-described examples may be combined in any suitable manner in various implementations.

The subject matter of the present disclosure includes all novel and nonobvious combinations and subcombinations of the various processes, systems and configurations, and other features, functions, acts, and/or properties disclosed herein, as well as any and all equivalents thereof.

1. On a computing device, a method for predicting fuel usage for a vehicle, the method comprising:
obtaining map information for a trip having a route;
obtaining road characteristic information for the route from the map information, the road characteristic information defining road features for the route;
obtaining a plurality of trip features from the map information and road characteristic information, the plurality of trip features comprising effects of the road features on a vehicle traveling the route;
obtaining vehicle-specific parameters for the vehicle;
determining a predicted fuel usage for the trip from the vehicle-specific parameters and the plurality of trip features; and
outputting the predicted fuel usage.

2. The method of claim 1, wherein obtaining road characteristic information comprises obtaining the road features for each road segment of a plurality of road segments for the route and obtaining the plurality of trip features for each road segment.

3. The method of claim 1, further comprising, for each of the plurality of trip features, updating a model relating the road features to each trip feature.

4. The method of claim 1, wherein the road features comprise one or more of a road length, a road speed limit, a road grade, a road rolling resistance, a road change in potential energy, a road aerodynamic drag, rush hour velocity multipliers, and a number of stops.

5. The method of claim 1, wherein the plurality of trip features comprises one or more of an energy from burning fuel, an energy generated by an engine of the vehicle, a change in kinetic energy, a change in potential energy, an aerodynamic drag, a rolling resistance, and a standby energy.

6. The method of claim 1, wherein the vehicle-specific parameters comprise one or more of a vehicle mass, a frontal effective area, and an efficiency of an engine of the vehicle.

7. The method of claim 1, further comprising obtaining vehicle-specific parameters from vehicle specifications.

8. A machine-readable storage device comprising instructions executable by a mobile computing device to estimate fuel usage by a vehicle during a trip by:
obtaining sensor measurements from one or more sensors of the mobile computing device during the trip,
determining a plurality of trip features from the sensor measurements, each trip feature representing an aspect of one or more of energy produced and energy consumed during the trip;
obtaining vehicle-specific parameters of the vehicle;
determining an estimated fuel usage from the vehicle-specific parameters and the plurality of trip features;
outputting the estimated fuel usage; and
presenting feedback relating driving behaviors of a driver of the trip to the estimated fuel usage for the trip.

9. The device of claim 8, wherein the instructions executable to determine the plurality of trip features are executable to
segment the sensor measurements over time into epochs, wherein a duration of each epoch is sufficient to include a plurality of sensor measurements from each sensor;
sum over the sensor measurements from each sensor for each epoch, wherein the sum is performed based upon a fixed rate change between consecutive sensor measurements for each sensor,
and determine the plurality of trip features for each epoch based upon the sum.

10. The device of claim 9, wherein the instructions executable to determine the plurality of trip features are executable to omit epochs having sensor measurements for less than a threshold fraction of the epoch and to omit epochs having a time difference between two of the consecutive sensor measurements larger than a threshold time.

11. The device of claim 8, wherein the plurality of trip features comprises one or more of an energy from burning fuel, an energy generated by an engine of the vehicle, a change in kinetic energy, a change in potential energy, an aerodynamic drag, a rolling resistance, and a standby energy.

12. The device of claim 8, wherein the sensor measurements comprise one or more of a vehicular speed, a location of the vehicle, a slope of a road segment of the trip, a fuel injection rate, an engine revolutions-per-minute speed, and a torque.

13. The device of claim 8, wherein the vehicle-specific parameters comprise one or more of a vehicle mass, a frontal effective area, and an efficiency of an engine of the vehicle.

14. The device of claim 8, wherein the instructions executable to obtain the vehicle-specific parameters are executable to learn the vehicle-specific parameters from a relationship between the plurality of trip features and the estimated fuel usage.

15. The device of claim 8, wherein the instructions executable to present feedback are executable to present comparative feedback comprising the feedback for the driver compared to additional feedback for a second driver, the additional feedback comprising relation of driving behavior of the second driver to a second estimated fuel usage for the second driver.

16. A mobile computing device, comprising:
a logic subsystem;
a data-holding subsystem comprising instructions executable by the logic subsystem to estimate fuel usage by a vehicle during a trip by
obtaining sensor measurements from one or more sensors of the mobile computing device during the trip,
determining a plurality of trip features from the sensor measurements, each trip feature representing an aspect of one or more of energy produced and energy consumed during the trip;
obtaining vehicle-specific parameters of the vehicle;
determining an estimated fuel usage from the vehicle-specific parameters and the plurality of trip features; and
receiving from an on-board diagnostics device information related to a current energy generated by an engine of the vehicle;
determining an estimated fuel usage from the vehicle-specific parameters and the plurality of trip features;
outputting the estimated fuel usage; and
presenting feedback relating driving behaviors of a driver of the trip to the estimated fuel usage for the trip.

17. The mobile computing device of claim 16, further comprising instructions executable by the logic subsystem to obtain the sensor measurements from the on-board diagnostics device and to update a function of the mobile computing device to learn the on-board diagnostics device information based upon the sensor measurements obtained from the on-board diagnostics device.

18. The mobile computing device of claim 16, wherein the on-board diagnostics device information comprises one or more of a fuel injection rate, a vehicular speed, an engine revolutions-per-minute speed, and a torque.

19. The mobile computing device of claim 16, wherein the plurality of trip features comprises one or more of an energy from burning fuel, an energy generated by an engine of the vehicle, a change in kinetic energy, a change in potential energy, an aerodynamic drag, a rolling resistance, and a standby energy.

20. The mobile computing device of claim 16, wherein the instructions executable to present feedback are executable to present comparative feedback comprising the feedback for the driver compared to additional feedback for a second driver, the additional feedback comprising relation of driving behavior of the second driver to a second estimated fuel usage for the second driver.
